(19) United States
(12) Patent Application Publication
(10) Pub. No.: US 2026/0163888 A1
(43) Pub. Date: Jun. 11, 2026

(54) CENTRALIZED ACCESS CONTROL ACROSS MULTIPLE ACCESS TECHNOLOGIES

(71) Applicant: Charter Communications Operating, LLC, St. Louis, MO (US)

(72) Inventors: Vishal G. Chopade, Denver, CO (US); Mohamed Daoud, Aurora, CO (US); Hany Heikal, Aurora, CO (US)

(73) Assignee: Charter Communications Operating, LLC, St. Louis, MO (US)

(21) Appl. No.: 18/975,864

(22) Filed: Dec. 10, 2024

(51) Int. Cl. H04L 9/40

(52) U.S. Cl. CPC H04L 63/108; H04L 63/1408; H04L 63/1483

(57) ABSTRACT

Methods, devices, and systems for providing a centralized access control system. A method includes receiving, at a control policy database, control policies for devices registered with the system. A machine learning engine updates the control policies to include websites identified by the machine learning engine as malicious. The system receives a request for access by a registered device using one of the multiple access platforms, determines a control policy for the registered device based on a variety of parameters including an access platform type of the multiple access platforms, and sends an access decision based on the determined control policy to an access device associated with the access platform type.

### TECHNICAL FIELD

This disclosure relates to communications. More specifically, this disclosure relates to access control with respect to communications access.

### BACKGROUND

Managing internet access across multiple devices is a critical challenge for both parents and small businesses. Solutions are fragmented, focusing on individual devices or platforms. This results in monitoring, controlling, and ensuring safe use labor-intensive and often ineffective. With the proliferation of internet-enabled devices, including but not limited to, smartphones, tablets, gaming consoles, and routers, parents and small business owners need a centralized, user-friendly system to enforce consistent rules and manage access efficiently.

Existing approaches lack contextual filtering, adaptability to user behavior, and effective integration across multiple connection types (e.g., home routers, cellular networks). The absence of dynamic, AI-driven controls and the difficulty of managing numerous device-specific policies contribute to subpar safety and efficiency. Furthermore, small businesses face challenges in regulating work phones and ensuring proper usage, highlighting the need for a versatile solution that can meet both parental and professional needs.

### SUMMARY

Disclosed is a system and method for centralized access control across multiple access technologies.

In implementations, a method for centralized access control includes receiving, at a control policy database in a centralized access control system, control policies for devices registered with the centralized access control system, where the control policies are used seamlessly across multiple access platforms, updating, by a machine learning engine of the centralized access control system, the control policies to include websites identified by the machine learning engine as malicious, receiving, by the centralized access control system, a request for access by a registered device using one of the multiple access platforms, determining, by the centralized access control system, a control policy for the registered device based on a variety of parameters including an access platform type of the multiple access platforms, and sending, by the centralized access control system, an access decision based on the determined control policy to an access device associated with the access platform type.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example centralized access control system in accordance with embodiments of this disclosure.

FIG. 2 is a diagram of an example access sequence in accordance with embodiments of this disclosure.

FIG. 3 is a diagram of an example access sequence in accordance with embodiments of this disclosure.

FIG. 4 is a flowchart of an example machine learning analysis in accordance with embodiments of this disclosure.

FIG. 5 is a flowchart of an example unified control in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for centralized access control across multiple access technologies. The system and method can provide a unified, comprehensive control solution for managing internet and network access across a wide variety of devices in a household or small business environment. In implementations, a universal, centralized system is provided that integrates cloud-based databases, secure routing, machine learning (ML) powered filtering, dynamic usage profiles, and multi-layer architecture. The result is a more effective and simplified way for parents and small businesses to control and monitor network access, ensuring safety and compliance across all connected devices.

In implementations, artificial intelligence (AI)-powered contextual filtering and/or ML powered filtering can recognize patterns and understand the context of content beyond simple keyword filtering. As an illustrative example, this smarter filtering can distinguish between academic information and inappropriate material.

In implementations, a centralized system can manage internet and network access across multiple devices within a household or small business. The centralized system can address the fragmentation of current solutions by providing a unified system that integrates both local and cloud-based components. The centralized system is an adaptive system which can include AI-powered contextual filtering, dynamic device usage profiles, application-level controls, and multi-layer architecture for secure routing and effective content management. The centralized system can also offer detailed insights, location-based controls, geofencing, and health monitoring integrations, making it a versatile solution for both parental and professional environments.

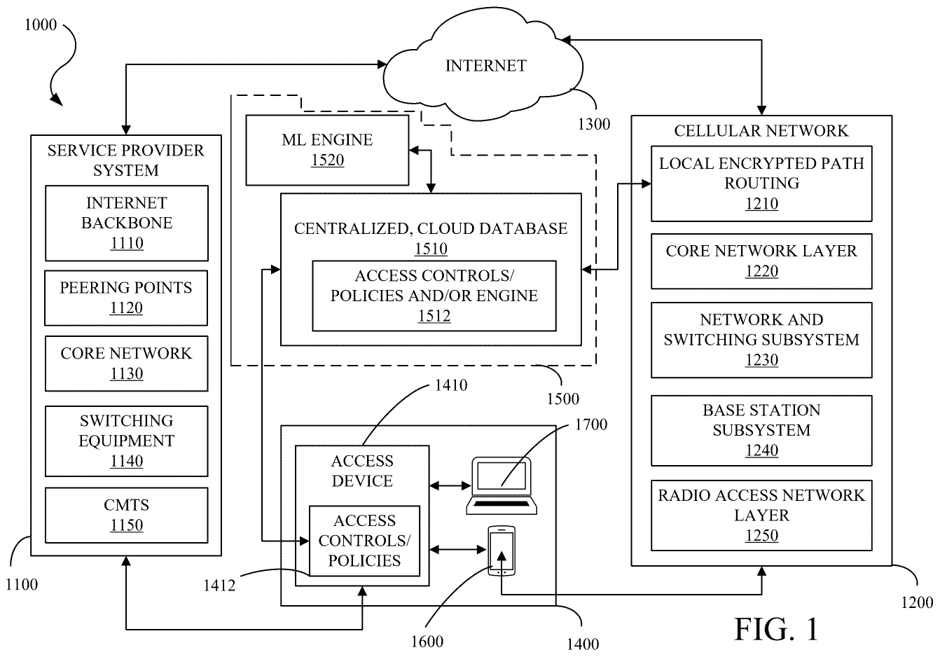

FIG. 1 is a diagram of an example access system 1000 in accordance with embodiments of this disclosure. In implementations, the access system 1000 can include, but is not limited to, a service provider system 1100, a cellular network 1200, an internet network 1300, a premises 1400, and a centralized access control system 1500. In implementations, the service provider system 1100 can include, but is not limited to, an internet backbone 1110, peering points 1120, core network 1130, switching equipment 1140, and a cable modem termination system (CMTS) 1150. In implementations, the cellular network 1200 can include, but is not limited to, a local encrypted path router 1210, core network layer 1220, network and switching subsystem 1230, base station subsystem 1240, and a radio access network layer 1250. In implementations, the premises 1400 can include, but is not limited to, an access device 1410, which includes access controls and/or policies 1412. In implementations, the centralized access control system 1500 can include, but is not limited to, a centralized cloud database 1510 and a machine learning (ML) engine 1520. In implementations, the centralized cloud database 1510 can include, but is not limited to, access controls and/or policies 1512.

In implementations, the service provider system 1100 can provide access to the internet network 1300 via the access device 1410 to devices, such as but not limited to, a mobile device 1600, a laptop 1700, and/or combinations thereof. The devices can be connected to the access device 1410 via wired and/or wireless connections such as but not limited to, WiFi, Ethernet, and/or combinations thereof. Access is controlled as described herein.

In implementations, the cellular network 1200 can provide access to the internet network 1300 to wirelessly connected devices, such as but not limited to, the mobile device 1600. Access is controlled as described herein.

In implementations, the local encrypted path router 1210 can provide a secure channel for transmitting data between a base station and the devices (e.g., the mobile device 1600 and/or the laptop 1700). The local encrypted path router 1210 can ensure that sensitive information is encrypted, which can maintain privacy and prevent unauthorized access. The local encrypted path router 1210 can also enable a network provider to apply parental control filters without compromising user privacy. Only websites identified by the centralized cloud database 1510 and the control policies therein as inappropriate are restricted, while all other content remains accessible. The local encrypted path router 1210 is a local server maintained by a service provider. It is a last gateway before connecting to the internet. The local nature of this component can ensure seamless browsing without impacting speed or latency.

In implementations, the centralized cloud database 1510 can act as a core repository for all control policies 1512 such as, but not limited to, parental controls, business policies, and the like. The centralized cloud database 1510 can facilitate the storage and retrieval of access rules, controls, and/or policies, allowing seamless communication between various elements of the network including, but not limited to, cellular access, premise-based access, satellite access, and/or combinations thereof. In implementations, the centralized cloud database 1510 can interface with both the access device 1410 and connected service provider system 1100, and the cellular network 1200 to control access consistently across all access technologies. The centralized cloud database 1510 can check which devices have what type of control policy based on identifiers including, but not limited to, model number, MAC ID, and IMEI of the device. This can ensure that the appropriate control policies are enforced on each individual device.

In implementations, the centralized access control system 1500 can enable access enforcement for devices attempting to obtain access via the service provider system 1100, the cellular network 1200, and/or other access technologies by enabling interaction at and/or with components of the service provider system 1100, the cellular network 1200, and/or other access technologies. As a non-limiting illustrative example, the centralized access control system 1500 can work with the access device 1410 to control access via the service provider system 1100. As a non-limiting illustrative example, the centralized access control system 1500 can work with the local encrypted path router 1210 and the other components, such as the core network layer 1220, the network and switching subsystem 1230, the base station subsystem 1240, and the radio access network layer 1250, to control access via the cellular network 1200. These components can work together to create a controlled pathway for data flow, enabling access and/or control rules to be enforced even when devices connect via different network mediums. The centralized access control system 1500 can check which devices have what type of control policy based on identifiers including, but not limited to, model number, MAC ID, and IMEI of the device. This can ensure that the appropriate control policies are enforced on each individual device.

In implementations, the access device 1410 can provide wired and/or wireless connectivity to devices such as, but not limited to, the mobile device 1600, the laptop 1700, and/or combinations thereof. Access is controlled as described herein. In implementations, the access device 1410 can be configured with the access and/or control policies 1412. The access device 1410 can act as a first point of enforcement for access and/or control rules. This ensures that any device attempting to connect to the internet via the access device 1410 must adhere to predefined policies regarding time limits, content restrictions, and device-specific access. To maintain an updated record of these activities, the access device 1410 can send relevant device data to the centralized cloud database 1510 in real-time using a defined format such as the JSON format. The data includes identifiers such as the model number, MAC ID, IMEI, and the specific policies applied to each device. Additionally, a username (e.g., “Harry's iPhone”) can be used to provide a user-friendly identification of the device. Accordingly, devices such as computers, mobile device 1600, laptop 1700, and tablets, are monitored via integration with the access device 1410. The setting of the access controls can allow a user, such as a parent, to enforce policies based on device type, user profile, content category, and/or combinations thereof. This feature and/or capability can provide fine-grained control over what content each individual user and/or associated device is able to access. Table 1 provides an illustration of blocking certain content at defined times for identified devices.

TABLE 1

```
{
  “user_name”: “Harry's iPhone”,
  “device_model”: “iPhone 13 Pro”,
  “mac_id”: “E4:6F:13:A2:7B:C5”,
  “imei”: “356941071204169”,
  “policies_applied”: {
    “time_limits”: {
      “start_time”: “06:00”,
      “end_time”: “22:00”
    },
    “content_restrictions”: [
      “block_gaming_sites”,
      “block_social_media”
    ],
    “allowed_access”: true
  },
  “last_sync_time”: “2024-10-07T14:35:00Z”
}
```

In implementations, the centralized access control system 1500 can provide both network-level and device-level monitoring to create a multi-layer safety net. For example, the core network layer 1220, the network and switching subsystem 1230, and the radio access network (RAN) layer 1250 of the cellular network 1200 are incorporated to enable comprehensive enforcement of access policies regardless of the device's connection type.

Operationally, a user can provide and/or input a defined set of control policies via an access interface to the access device 1410 and save as the control policies 1412. The access device 1410 can then provide and/or transmit these control policies 1412 to the centralized cloud database 1510, where the received control policies 1412 can be stored as control policies 1512. Alternatively, in implementations, the user can provide and/or input a defined set of control policies via an access interface to the centralized cloud database 1510 and save the inputted control policies as control policies 1512. In implementations, the control policies 1512 can be updated by the user via the access device and/or directly to the centralized cloud database 1510. In implementations, the ML engine 1520 can update the control policies 1512 as described herein. In implementations, the access device 1410 can update the control policies 1412, as needed or on a defined time basis, using the control policies 1512.

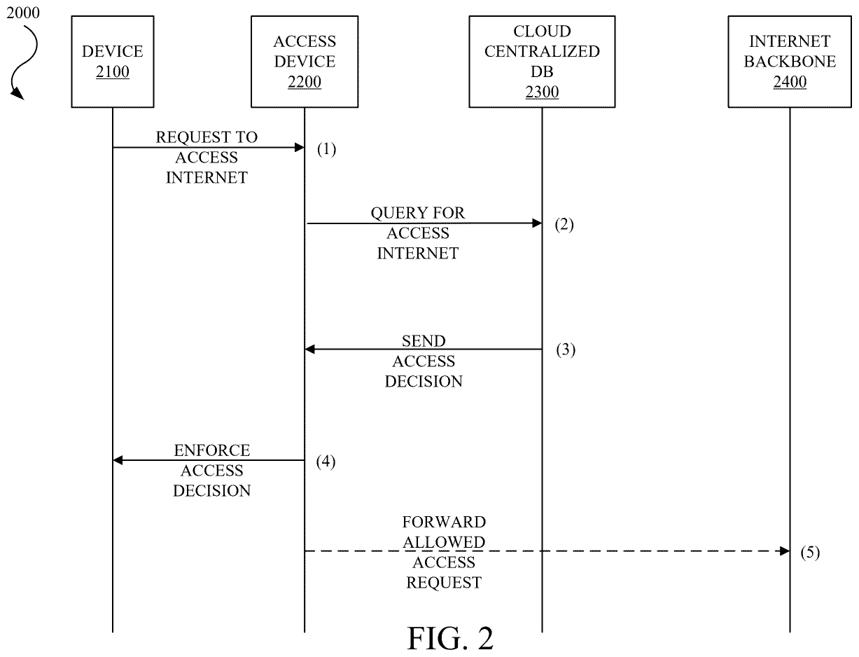

FIG. 2 is a diagram of an example access sequence 2000 in accordance with embodiments of this disclosure. In implementations, the access sequence 2000 can be implemented in and/or employed with a device 2100, an access device 2200, a cloud-centralized platform and/or database 2300, and an internet backbone 2400. In implementations, the device 2100 can be the mobile device 1600 and/or the laptop 1700, for example. In implementations, the access device 2200 can be the access device 1410, for example. In implementations, the cloud-centralized platform and/or database 2300 can be the centralized cloud and/or cloud-centralized platform and/or database 1510, for example. In implementations, the internet backbone 2400 can be the internet backbone 1110, for example.

Operationally, the device 2100 can send a request for internet access to the access device 2200 (1). In implementations, the request can include an identifier for the device 2100. The access device 2200 can send a query to the cloud-centralized platform 2300 in response to receiving the internet access request from the device 2100 (2). The cloud-centralized platform 2300 can review the control and/or access policies based on the identifier of the device 2100. The cloud-centralized platform 2300 can send the access decision to access device 2200 (3). The access decision can grant or deny internet access. The access device 2200 can enforce and/or apply the access decision with the device 2100 (4). If applicable, the access device 2200 can grant the device 2100 access to the internet backbone 2400 (5), which in turn connects to the internet.

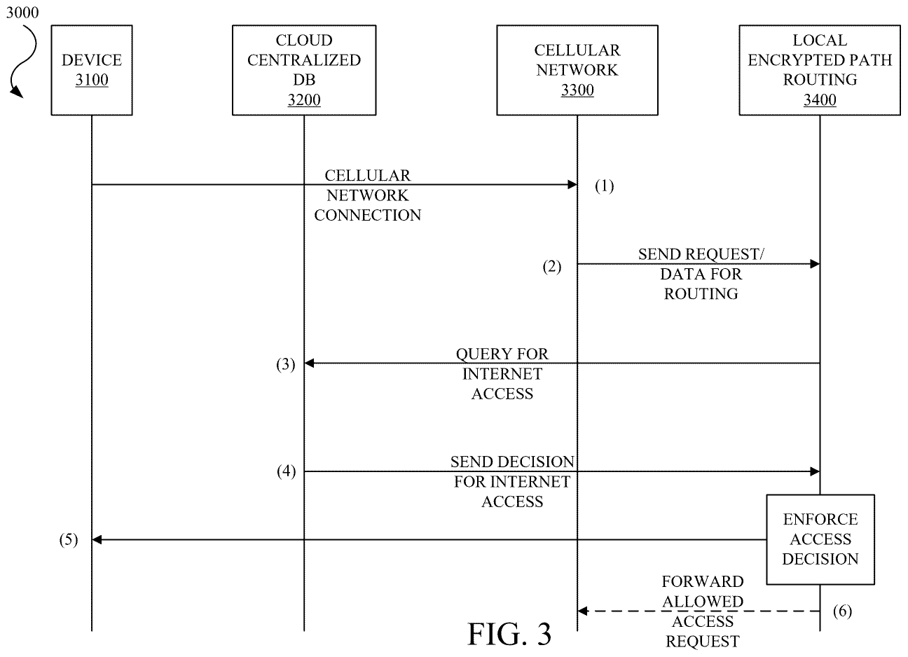

FIG. 3 is a diagram of an example access sequence 3000 in accordance with embodiments of this disclosure. In implementations, the access sequence 3000 can be implemented in and/or employed with a device 3100, a cloud-centralized platform and/or database 3200, cellular network 3300, and a local encrypted path router 3400. In implementations, the device 3100 can be the mobile device 1600 and/or the laptop 1700, for example. In implementations, the cloud-centralized platform and/or database 3200 can be the centralized cloud and/or cloud-centralized platform and/or database 1510, for example. In implementations, the cellular network 3300 can be the cellular network 1200, for example. In implementations, the local encrypted path router 3400 can be the local encrypted path router 1210, for example.

Operationally, the device 3100 can connect with the cellular network 3300 and send a request for internet connection (1). In implementations, the request can include an identifier for the device 3100. The cellular network 3300 can send a request and/or data to the local encrypted path router 1210 in response to receiving the internet access request from the device 3100 (2). The local encrypted path router 3400 can send a query to the cloud-centralized platform and/or database 3200 based on the received request and/or data (3). The cloud-centralized platform 3200 can review the control and/or access policies based on the identifier of the device 3100. The cloud-centralized platform 3200 can send the access decision to the local encrypted path router 3400 (4). The access decision can grant or deny internet access. The local encrypted path router 3400 can enforce and/or apply the access decision with the device 3100 (5). If applicable, the local encrypted path router 3400 can grant the device 3100 access to the cellular network 3300 and can forward the request from the device 3100 (6), which in turn connects to the internet.

In implementations, the ML engine 1520 can update the control policies 1512 based detected patterns and/or other information and/or data as described herein. In implementations, the ML engine 1520 can use ML models and machine learning algorithms and/or techniques to identify and categorize harmful, age-inappropriate, or productivity-disruptive websites. In a non-limiting illustrative example, the ML models can include BERT, GPT, Autoencoders, Isolation Forest, and/or the like which can understand and classify content contextually and detection anomalies in web usage, for example.

The ML engine 1520 and/or algorithms can learn from prior inputs and user intentions, suggest websites to block, and enhance the effectiveness of the centralized access control system 1500 in maintaining a secure and focused environment. The ML engine 1520, ML models, and ML algorithms (collectively “ML engine 1520” as appropriate and applicable) can operate in the cloud and continuously analyze patterns in user internet usage and exposure to high-risk websites. When the ML engine 1520 detects new patterns or repeated access to unsafe content, the ML engine 1520 can automatically update the parental policy categories over the air at the cloud-centralized platform and/or database 1510. The cloud-centralized platform and/or database 1510 can apply the updates to the relevant devices and adjust restrictions as needed. That is, the updated categories and policy changes are immediately reflected in the cloud-centralized platform and/or database 1510, ensuring real-time policy enforcement and consistent protection. Table 2 provides an illustration of updating the cloud-centralized platform and/or database 1510 by the ML engine 1520.

```
TABLE 2
{
  “billing_user”: {
    “username”: “harry_johnson”,
    “account_id”: “HJ123456789”
    },
  “router_info”: {
    “router_model”: “Netgear XR500”,
    “router_mac_id”: “A1:B2:C3:D4:E5:F6”,
    “firmware_version”: “V2.3.2.40”,
    “last_sync_time”: “2024-10-07T15:00:00Z”
  },
  “user_selected_categories”: [
    “block_social_media”,
    “block_adult_content”,
    “block_video_streaming”,
    “limit_gaming_time”
  ],
  “ml_updated_data”: {
    “newly_added_websites”: [
      {
        “website_url”: “www.darksocial.com”,
        “risk_level”: “high”,
        “reason_flagged”: “Potential social media site with high data-sharing activity”
      },
      {
        “website_url”: “www.videoflix.tv”,
        “risk_level”: “medium”,
        “reason_flagged”: “Streaming platform known to bypass restrictions”
      }
    ],
    “newly_updated_categories”: [
      {
        “category”: “block_social_media”,
        “updated_policies”: {
          “block_websites”: [
            “www.darksocial.com”,
            “www.wechat.com”
          ],
          “time_limits”: {
            “daily_limit”: “2 hours”
          }
        }
      },
      {
        “category”: “block_video_streaming”,
        “updated_policies”: {
          “block_websites”: [
            “www.videoflix.tv”,
            “www.streamhide.com”
          ],
          “content_quality_limit”: “480p”,
          “time_limits”: {
            “daily_limit”: “1 hour”
          }
        }
      }
    ],
    “potential_device_issues”: [
      {
        “device_name”: “Living Room Smart TV”,
        “mac_id”: “12:34:56:78:90:AB”,
        “issue_detected”: “Repeated connection to www.videoflix.tv causing slow network
speeds”,
        “recommended_action”: “Limit video streaming access on this device”
      },
      {
        “device_name”: “Harry's iPad”,
        “mac_id”: “98:76:54:32:10:BA”,
        “issue_detected”: “Potential unsafe content accessed on www.darksocial.com”,
        “recommended_action”: “Block access to the website immediately”
      }
    ]
  },
  “update_metadata”: {
    “update_source”: “ML Cloud Model”,
    “update_time”: “2024-10-07T15:30:00Z”,
    “update_status”: “Completed”
  }
}
```

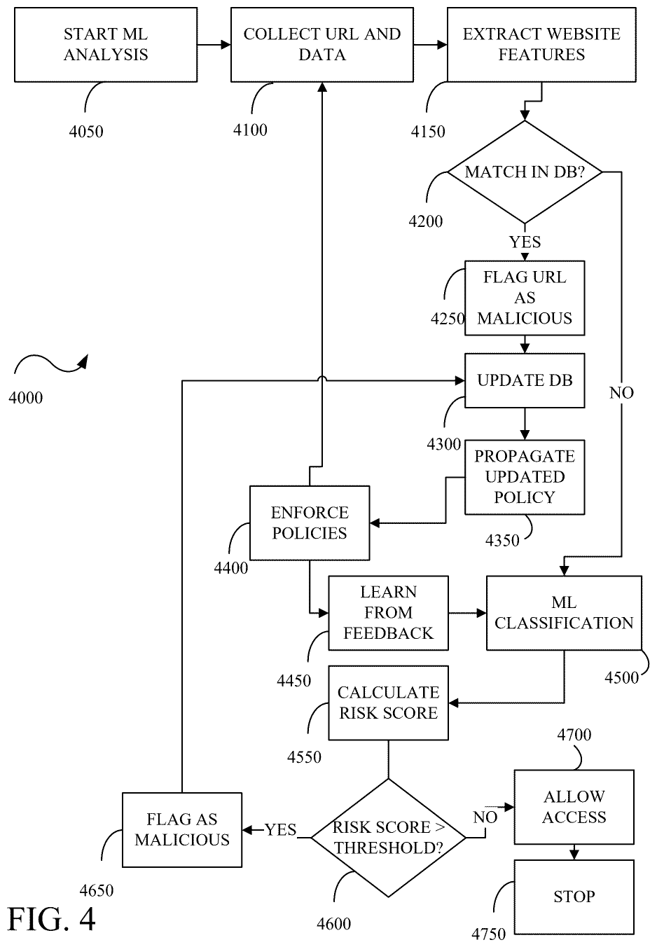

FIG. 4 is a flowchart of an example machine learning analysis method 4000 in accordance with embodiments of this disclosure. In implementations, the machine learning analysis method 4000 can be performed and/or executed by the ML engine 1520. The ML engine 1520 can start (4050) to gather malicious websites by continuously monitoring user activity across all connected devices and analyzing URL requests to detect and classify potentially harmful, inappropriate, or disruptive content (4100). To achieve this, the system initially relies on a predefined database of known malicious websites, which serves as a foundation for training the ML models in the ML engine 1520 to effectively distinguish between safe and dangerous sites.

The ML engine 1520 can then perform feature extraction (4150), where the ML algorithm captures various characteristics from each website, such as URL patterns, content type, metadata, and behavioral indicators. The ML models can gain a deeper understanding of the website's nature, analyzing metrics like visit frequency, high-risk keywords, unusual redirects, or suspicious requests. The ML engine 1520 can compare the extracted features for the websites against the features of the predefined database of known malicious websites (4200).

If there is a match against the database, then the ML engine 1520 can mark the website as malicious (4250). A centralized database (e.g., cloud-centralized platform and/or database 1510) acting as the core repository for all control policies can be updated (4300). The centralized database can promptly be update with the new flagged websites and/or URLs, and this updated information can be immediately propagated to all connected devices (e.g., premises routers and mobile networks) (4350), ensuring that emerging threats are swiftly blocked and the entire network remains secure (4400).

Any device attempting to access a flagged website is immediately blocked, following the defined policies. This ongoing integration between the centralized database, network infrastructure, and connected devices guarantees an active, adaptive security posture. Additionally, the ML model continuously refines its detection algorithms by learning from ongoing user interactions, flagged content, and feedback regarding false positives (4450). This continuous learning ensures the system becomes increasingly effective and precise in identifying and blocking harmful websites and adapting to new threats.

If there is no match against the database, and with this rich data, the ML engine 1520 can then apply clustering and classification techniques to categorize websites into different risk levels, such as high-risk social media, phishing sites, or portals distributing malicious downloads (4500). Websites flagged as suspicious are further analyzed to determine their level of threat. Once the classification is complete, the system assigns each URL a risk score based on content analysis, user interaction, metadata, and/or other determinative factors (4550). The risk score is compared against a defined threshold (4600). If the risk score exceeds the defined threshold, the website is marked as malicious (4650). At this point, the ML engine 1520 and/or ML model can automatically generate a defined format payload containing information about the flagged site, which is then sent to the centralized database (4300). The centralized database can promptly be update with the new flagged URLs, and this updated information can be immediately propagated to all connected devices, ensuring that emerging threats are swiftly blocked and the entire network remains secure (4350). The process then continues as described herein above. If the risk score is below the defined threshold, the access is granted (4700) and the process stops (4750).

The ML engine 1520 can proactively examine publicly accessible internet websites, adding new entries to the central database. It actively crawls and analyzes websites, comparing them against third-party databases and existing records to determine their risks. Whenever new websites are identified on the internet, the system analyzes them for malicious content, updating the database accordingly. This proactive approach ensures the database remains up to date with the latest threats, providing robust protection against emerging risks.

Moreover, the ML engine 1520 can integrate user feedback as an additional layer of refinement. Parents or business administrators can submit websites they consider harmful or inappropriate, allowing the database to cater to specific household or organizational needs. For example, parents may identify sites unsuitable for their children, or companies may flag websites deemed counterproductive or risky for employees. By incorporating this feedback, the ML engine 1520 can provide customized security measures that reflect the unique requirements of individual users, families, or workplaces.

In implementations, the above methodology can be applied to additional features which can increase the effective of the overall system.

In implementations, the ML engine 1520 can provide emotion-driven device control. The ML engine 1520 can be trained to learn and detect emotional tones in interactions and adjust device permissions accordingly to manage exposure and promote healthier content engagement. In a non-limiting illustrative example, a teenager posts negative content online, prompting the ML engine 1520 to restrict social media access and suggest relaxing applications.

In implementations, the ML engine 1520 can enable behavioral gamification with real-world rewards. The ML engine 1520 can be trained to promote positive device usage with real-world rewards for completing educational activities or maintaining good screen habits. In a non-limiting illustrative example, a child earns reward points for reducing gaming time and using educational applications, redeemable for tangible items like movie tickets.

In implementations, the ML engine 1520 can enable adaptive schedules with Circadian insights. The ML engine 1520 can be trained to create personalized schedules based on circadian rhythms, controlling screen time and content access to promote better sleep and productivity. In a non-limiting illustrative example, the ML engine 1520 can reduce screen brightness and block stimulating content before bedtime.

In implementations, the ML engine 1520 can enable a blockchain-based accountability system. The ML engine 1520 can be trained to integrate blockchain technology to create tamper-proof logs of device activities and permissions, useful for compliance and parental control. In a non-limiting illustrative example, a business uses blockchain to track device activity and ensure accountability.

In implementations, the ML engine 1520 can enable cross-environment control integration. The ML engine 1520 can be trained to enhance control by integrating with smart home systems to create distraction-free environments, such as controlling internet access and lighting during study time. In a non-limiting illustrative example, when study mode is activated, lights dim and social media access is restricted.

In implementations, the ML engine 1520 can enable proximity-based dynamic control. The ML engine 1520 can be trained to adjust restrictions based on the proximity of devices, enforcing stricter controls during group settings, such as a study session. In a non-limiting illustrative example, during a group study, the ML engine 1520 can limit social media access and encourages focus.

In implementations, the ML engine 1520 can enable content emotion classification and filtering. The ML engine 1520 can be trained to classify and filter content based on emotional tone, blocking content with aggressive language even if it isn't explicitly harmful. In a non-limiting illustrative example, the ML engine 1520 can block a website with derogatory language and suggests healthier alternatives.

This combination of proactive web crawling, automated machine learning classification, real-time policy enforcement, and personalized user feedback ensures that the centralized control solution is comprehensive and adaptable, providing a safe, secure, and tailored experience for all users.

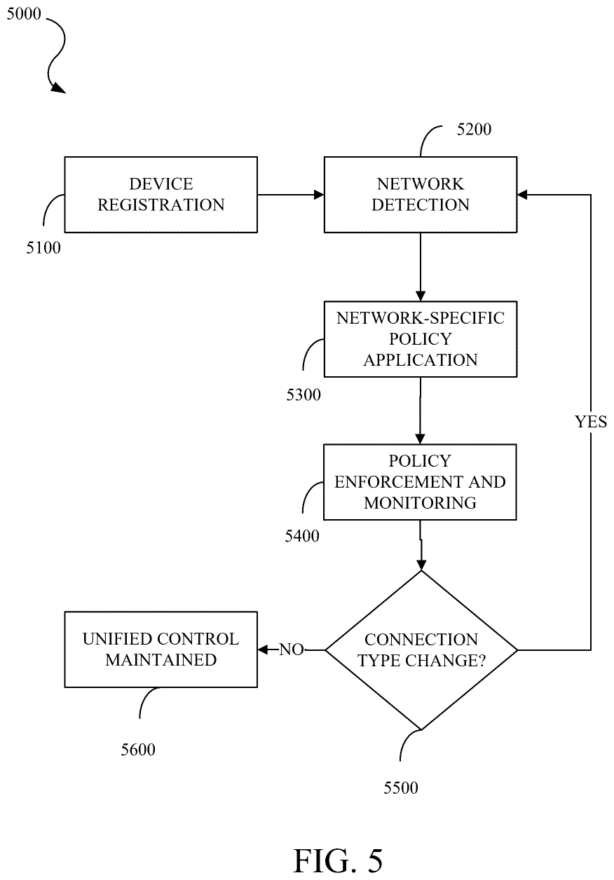

FIG. 5 is a flowchart of an example unified control method 5000 in accordance with embodiments of this disclosure. The method 5000 includes registering 5100 a device with a centralized access control system; determining 5200 a network connection type; determining 5300 policies based on the network connection type; enforcing 5400 the determined policies; checking 5500 for change in network connection type; and maintaining 5600 enforcement of the policies when no change in the network connection type. The method 5000 can be implemented, for example, in or by components described with respect to FIG. 1 and in conjunction with any of the flows described with respect to FIGS. 2-4, as appropriate and applicable.

The method 5000 includes registering 5100 a device with a centralized access control system. User devices including, but not limited to, mobile devices, laptops, smart televisions, and internet-connectable devices, can be registered with a centralized access control system. Parents, business owners, IT personnel, and/or similarly situated personnel can input control policies for each of the registered devices as described herein. The control policies can be applicable to any type of network connection type and/or access system, can vary for different network connection types, and/or combinations thereof. In a non-limited illustrative example, the centralized access control system can operate with multiple access systems including, but not limited to, 5G, 4G, FWA, Citizens Broadband Radio Service (CBRS), fiber networks, hybrid fiber-coaxial system providers, and satellite networks. This ensures consistent device management and monitoring across different platforms. Parents and/or business owners can manage their children's/employees' device access and content restrictions seamlessly, whether they're connected via cellular, fiber, or satellite networks. The registration can include device identifier information.

The method 5000 includes determining 5200 a network connection type. The centralized access control can determine whether a device is connected via a WiFi connection, cellular connection, satellite connection, wired connection, and/or combinations thereof.

The method 5000 includes determining 5300 control policies based on the network connection type. The centralized access control can use the device identifier information to determine which control policies to review.

The method 5000 includes enforcing 5400 the determined policies. The determined control policies can then be sent by the centralized access control system to access devices and/or components in the respective access system, which in turn can enforce the control policy by granting or denying access.

The method 5000 includes checking 5500 for change in network connection type. The centralized access control system continues to monitor the network connection types of devices requesting access.

The method 5000 includes maintaining 5600 enforcement of the policies when no change in the network connection type. The centralized access control system can maintain application of the current control policies or re-determine the control policies if there is a change in the network connection type.

The centralized access control system can provide a unified parental control solution that simplifies and consolidates access rules, making it easier for parents to manage and restrict internet use across all household devices effectively. Similarly, the centralized access control system can be used by small businesses to regulate and monitor the use of work phones and ensure compliance with company policies.

Described herein is a method for centralized access control across multiple access technologies. In implementations, a method includes receiving, at a control policy database in a centralized access control system, control policies for devices registered with the centralized access control system, wherein the control policies are used seamlessly across multiple access platforms, updating, by a machine learning engine of the centralized access control system, the control policies to include websites identified by the machine learning engine as malicious, receiving, by the centralized access control system, a request for access by a registered device using one of the multiple access platforms, determining, by the centralized access control system, a control policy for the registered device based on a variety of parameters including an access platform type of the multiple access platforms, and sending, by the centralized access control system, an access decision based on the determined control policy to an access device associated with the access platform type.

In implementations, the updating further includes collecting, by the machine learning engine, website data, extracting, by the machine learning engine, features associated with each website in the website data, classifying, by the machine learning engine, a website absent in the control policy database, determining, by the machine learning engine, a risk score for each absent website, and flagging, by the machine learning engine, each absent website as malicious when a determined risk score exceeds a defined threshold. In implementations, the updating further includes using, by the machine learning engine, feedback from enforcement actions related to the control policies to update a machine learning classification. In implementations, the updating further includes collecting, by the machine learning engine, website data, extracting, by the machine learning engine, features associated with each website in the website data, and marking, by the machine learning engine, a website as malicious when extracted features match features for websites in the control policy database. In implementations, the method further includes monitoring, by the centralized access control system, changes in the access platform type, re-assessing, by the centralized access control system, the control policy for the registered device due to a change in the access platform type, and sending, by the centralized access control system, an access decision based on the reassessed control policy to the access device. In implementations, the control policies are equally applicable across each of the multiple access platforms. In implementations, the control policies are differentially applicable across each of the multiple access platforms.

Described herein is a centralized access control system. In implementations, the centralized access control system includes a control database configured to store access rules for devices registered with the centralized access control system, wherein the access rules are used seamlessly useable across different access technologies, and a machine learning engine connected to the control policy database. The machine learning engine configured to monitor websites to collect website data, extract features associated with each website in the website data, classify each website which is missing from the control database, determine a risk score for each missing website, mark each missing website as malicious when a determined risk score exceeds a defined threshold, and update the control database.

In implementations, the control database is further configured to determine an access rule for a request sent by a registered device, the access rule based on an access technology connection type, and send an access decision based on the determined access rule to an access component associated with the access technology connection type. In implementations, the machine learning engine is further configured to apply feedback from enforcement actions related to the access rules to update machine learning classification. In implementations, the machine learning engine is further configured to label a website as malicious when extracted features match features for websites in the control database. In implementations, the control database is further configured to re-assess the access rule for the registered device due to a change in the access technology connection type, and send an access decision based on the reassessed access rule to the access device. In implementations, the access rules are equally applicable across each of the access technologies. In implementations, the access rules are differentially applicable across each of the access technologies.

Described herein is system including a first access system, a second access system different from the first access system, and a centralized access control system connected to the first access system and the second access system. The centralized access control system is configured to store, in a control database access, control policies for devices registered with the centralized access control system, wherein the control policies are used seamlessly useable across the first access system and the second access system, update, using a machine learning engine, the control policies to include websites identified by the machine learning engine as malicious, receive, from one of the first access system and the second access system, a request for access by a registered device, determine a control policy for the registered device based on which of the first access system and the second access system is being used for access by the registered device, and send an access decision based on the determined control policy to an access component associate with the one of the first access system and the second access system.

In implementations, one of the first access system and the second access system further includes a local encrypted path router connected to the centralized access control system, the local encrypted path router is configured to enable a provider associated with the first access system or the second access system to apply control filters while maintaining user privacy. In implementations, the machine learning engine is further configured to monitor websites to collect website data, extract features associated with each website in the website data, classify each website which is missing from the control database, determine a risk score for each missing website, and mark each missing website as malicious when a determined risk score exceeds a defined threshold.

Although some embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for centralized access control, the method comprising:
receiving, at a control policy database in a centralized access control system, control policies for devices registered with the centralized access control system, wherein the control policies are used seamlessly across multiple access platforms;
updating, by a machine learning engine of the centralized access control system, the control policies to include websites identified by the machine learning engine as malicious;
receiving, by the centralized access control system, a request for access by a registered device using one of the multiple access platforms;
determining, by the centralized access control system, a control policy for the registered device based on a variety of parameters including an access platform type of the multiple access platforms; and
sending, by the centralized access control system, an access decision based on the determined control policy to an access device associated with the access platform type.

2. The method of claim 1, wherein the updating further comprises:
collecting, by the machine learning engine, website data;
extracting, by the machine learning engine, features associated with each website in the website data;
classifying, by the machine learning engine, a website absent in the control policy database;
determining, by the machine learning engine, a risk score for each absent website; and
flagging, by the machine learning engine, each absent website as malicious when a determined risk score exceeds a defined threshold.

3. The method of claim 2, wherein the updating further comprises:
using, by the machine learning engine, feedback from enforcement actions related to the control policies to update a machine learning classification.

4. The method of claim 1, wherein the updating further comprises:
collecting, by the machine learning engine, website data;
extracting, by the machine learning engine, features associated with each website in the website data; and
marking, by the machine learning engine, a website as malicious when extracted features match features for websites in the control policy database.

5. The method of claim 1, wherein the method further comprises:
monitoring, by the centralized access control system, changes in the access platform type;
re-assessing, by the centralized access control system, the control policy for the registered device due to a change in the access platform type; and
sending, by the centralized access control system, an access decision based on the reassessed control policy to the access device.

6. The method of claim 1, wherein the control policies are equally applicable across each of the multiple access platforms.

7. The method of claim 1, wherein the control policies are differentially applicable across each of the multiple access platforms.

8. A centralized access control system, comprising:
a control database configured to store access rules for devices registered with the centralized access control system, wherein the access rules are used seamlessly useable across different access technologies; and
a machine learning engine connected to the control database, the machine learning engine configured to:
monitor websites to collect website data;
extract features associated with each website in the website data;
classify each website which is missing from the control database;
determine a risk score for each missing website;
mark each missing website as malicious when a determined risk score exceeds a defined threshold; and
update the control database.

9. The centralized access control system of claim 8, wherein the control database is further configured to:
determine an access rule for a request sent by a registered device, the access rule based on an access technology connection type; and
send an access decision based on the determined access rule to an access component associated with the access technology connection type.

10. The centralized access control system of claim 8, wherein the machine learning engine is further configured to:
apply feedback from enforcement actions related to the access rules to update machine learning classification.

11. The centralized access control system of claim 8, wherein the machine learning engine is further configured to:
label a website as malicious when extracted features match features for websites in the control database.

12. The centralized access control system of claim 9, wherein the control database is further configured to:
re-assess the access rule for the registered device due to a change in the access technology connection type; and
send an access decision based on the reassessed access rule to the access device.

13. The centralized access control system of claim 8, wherein the access rules are equally applicable across each of the access technologies.

14. The centralized access control system of claim 8, wherein the access rules are differentially applicable across each of the access technologies.

15. A system, comprising:
a first access system;
a second access system different from the first access system; and
a centralized access control system connected to the first access system and the second access system, wherein the centralized access control system is configured to:
store, in a control database access, control policies for devices registered with the centralized access control system, wherein the control policies are used seamlessly useable across the first access system and the second access system;
update, using a machine learning engine, the control policies to include websites identified by the machine learning engine as malicious;
receive, from one of the first access system and the second access system, a request for access by a registered device;
determine a control policy for the registered device based on which of the first access system and the second access system is being used for access by the registered device; and
send an access decision based on the determined control policy to an access component associated with the one of the first access system and the second access system.

16. The system of claim 15, wherein one of the first access system and the second access system further comprises:
a local encrypted path router connected to the centralized access control system, the local encrypted path router is configured to enable a provider associated with the first access system or the second access system to apply control filters while maintaining user privacy.

17. The system of claim 15, wherein the machine learning engine is further configured to:
monitor websites to collect website data;
extract features associated with each website in the website data;
classify each website which is missing from the control database;
determine a risk score for each missing website; and
mark each missing website as malicious when a determined risk score exceeds a defined threshold.

18. The system of claim 15, wherein the centralized access control system is further configured to:
monitor changes in an access platform type, wherein the access platform type includes at least the first access system and the second access system;
re-assess the control policy for the registered device due to a change in the access platform type; and
send an access decision based on the reassessed control policy to an access component associated with the access platform type.

19. The system of claim 15, wherein the control policies are equally applicable across at least the first access system and the second access system.

20. The system of claim 15, wherein the control policies are differentially applicable across at least the first access system and the second access system.
